(19) United States
(12) Patent Application Publication
(10) Pub. No.: US 2010/0247709 A1
(43) Pub. Date: Sep. 30, 2010

(54) SALT MIXTURE WITH LOW SODIUM CONTENT FOR HUMAN

(75) Inventor: Pontus Ryberg, Halmstad (SE)

Correspondence Address: KNOBBE MARTENS OLSON & BEAR LLP, 2040 MAIN STREET, FOURTEENTH FLOOR, IRVINE, CA, 92614, US

(73) Assignee: AB HANSON & MOHRING, HALMSTAD (SE)

(21) Appl. No.: 12/438,347

(22) PCT Filed: Aug. 23, 2007
(86) PCT No.: PCT/SE2007/000745

§ 371 Date: May 13, 2010

(30) Foreign Application Priority Data
Aug. 23, 2006 (SE) 0601795-8

(51) Int. Cl. A23L 1/304; A23G 4/06; A23L 1/237; A23L 2/52

(52) U.S. Cl. 426/3; 426/74; 426/649

(57) ABSTRACT

The present invention relates to a salt mixture with low sodium content for human consumption which comprises sodium chloride, potassium chloride, magnesium sulphate, calcium carbonate, folic acid and zinc oxide. The mixture can also comprise potassium iodide and/or a flavouring additive. The present invention further relates to a food, a food supplement and a functional food comprising said salt mixture, and to the use of the salt mixture in food.

### TECHNICAL FIELD

The present invention relates to a salt mixture with low sodium content, a food, a food supplement and a functional food containing the same, and to use of the salt mixture in food, as well as in industrial and private cooking and as a table salt.

### BACKGROUND

Today high blood pressure, hypertension, is a widespread disease. There are many causes for this condition, but in most cases it is due to heredity and diet. Salt, i.e. sodium chloride, alcohol, sugar, coffee and a high total calorie intake are some of the dietetic factors which are believed to have the greatest impact on the blood pressure. In the case of young women, high blood pressure can also be caused by use of contraceptive pills.

In the body, sodium chloride affects, among other things, the osmotic pressure in the cells, a certain intake of salt via the diet thus being necessary. Sodium chloride is also an important flavouring, but studies have shown that on average 20% of our daily salt intake would be sufficient. Sodium chloride retains water, and the effect in the body is that a high salt intake increases the blood volume. This in turn leads to increased blood pressure. In the long run, the blood vessels also get narrower, a condition which is called hypertension (i.e. high blood pressure). Hypertension is associated with an increased risk of developing cardiovascular diseases (e.g. blood clots). The secretion of salt is controlled by the kidneys according to supply and need.

The Swedish National Food Administration recommends a maximum daily intake of 5 g salt (NaCl), whereas in the Nordic Nutrition Recommendations (Nordiska Naringsrekommendationerna, NNR) from 2004 a maximum intake of 6 g/day for women and 7 g/day for men is recommended. The American Food and Drug Agency (FDA) and the British Food Standards Agency both recommend 6 g/day maximum. On average, the salt intake in Sweden is 8-10 g/day per person.

Sodium, together with potassium, controls the vital liquid-electrolyte balance. Potassium is also important for the function of the kidneys, for instance, for activating a great number of enzymes and for regulating the heart rhythm. Potassium also has a blood pressure lowering effect, and it is thus very important to keep the potassium to sodium ratio as high as possible, optimally 5:1. In today's diet, this ratio is in most cases 1:2. Potassium also affects the acid-base balance in the blood. If potassium leaches out of the body, which mostly happens by urine excretion due, for instance, to medicines (e.g. diuretic, laxative) or a high intake of coffee, alcohol or sugar or to digestive disturbances (diarrhoea, vomiting), this may result in muscle cramps, cardiac arrest and, in less sever cases, disturbances in the heart rhythm, oedema, chronic constipation, hypoglycaemia, kidney troubles and increased blood pressure. Potassium is also a mineral that easily leaches out of vegetable and animal food, for instance, when boiled. The Swedish National Food Administration recommends a daily potassium intake of about 3-3500 mg for adults.

In conditions treated with diuretics, such as high blood pressure, the body loses not only potassium but also magnesium. Magnesium, in combination with potassium, is an important mineral to prevent high blood pressure, and the body cannot store potassium in the absence of magnesium. Magnesium is also an important mineral for the production of ATP, to maintain normal muscle function, keep the heart rhythm steady, support the immune defense and develop a strong skeleton. As magnesium is also involved in all neogenesis, it may be particularly important, for instance, for people doing a lot of sport or for pregnant women to get sufficient amounts. Also people living under stress have an increased need of magnesium. In the presence of sufficient amounts of both potassium and magnesium, excretion of sodium and excess liquid is favoured. Some drugs (e.g. diuretics), badly treated diabetes, a high intake of alcohol and chronic digestive diseases can lead to a deficiency of magnesium.

Up to 30% of all people having high blood pressure secrete calcium in their urine, and in these cases it may be suitable to add calcium to the diet, about 2 g/day, for those sensitive to salt (NaCl). Calcium is a very important mineral for the growth and healing of bones and teeth as well as for the hormone production. Calcium is also an important factor, for instance, for the nerve impulses in muscle contraction, thus contributing to normal muscle function. Calcium also contributes to coagulation of blood.

Folic acid (a vitamin B) has been found to have certain blood pressure lowering effects, but it can be difficult to achieve a sufficiently high intake of folic acid through regular diet. The recommended daily intake for adults is 300 mg. Today (since January 2001), the Swedish Board of Health and Welfare, the Swedish National Food Administration and prenatal clinics recommend women in fertile age, in particular those planning to get pregnant, to eat at least 400 micrograms (0.4 mg) folic acid a day, as folic acid has a beneficial effect on pregnancy and the development of the foetus and reduces the risk of children being born with myelocele. In the USA, Canada and some other countries, flour is, for instance, fortified with folic acid, and these countries report reduced risks of, for instance, myelocele. Owing to this, there are discussions going on also in the Scandinavian countries whether recommendations should be made to fortify food with folic acid, as is already the case with the fortification of salt with iodine.

Folic acid also plays an important part in protein production and cell division, and folic acid deficiency affects the regeneration of cells, which is first seen in fast-growing cells, such as red and white blood cells. Lack of folic acid is also associated with chromosome defects in the cells.

Smoking increases the need of folic acid, as folic acid is destroyed by tobacco smoke. People with a high intake of alcohol often have a deficiency of folic acid. It has also been found that folic acid can inhibit the formation of homocysteine, a conversion product of the amino acid metionine, which for very good reasons is considered as a risk factor for cardiovascular diseases.

Folic acid is found in fruit and vegetable, but it is easily destroyed in heating. Much folic acid can thus be lost in food cooking. Heating, for instance in a micro-wave oven, as well as light also destroy much of the folic acid. Since folic acid is water-soluble, it is also easily lost in cooking. Owing to this, an extra addition of folic acid to food could inhibit the negative effects of, for instance, heating and boiling.

Zinc is a trace metal of vital importance for the human body, which is present in a total amount of 2-3 grams stored in the bones and the muscles. The recommended daily intake of zinc varies with age and sex in the range of 7-11 mg/day. Zinc is included in more than 300 enzymes and can act as an antioxidant, which makes it important for the immune defense. Zinc is important for the carbohydrate metabolism and the protein synthesis. In case of zinc deficiency, a number of disorders may arise, such as cutaneous affections, circulatory and blood diseases such as arteriosclerosis, high blood pressure and anaemia. Lack of zinc also makes the arteries hard, fragile and inflamed instead of being naturally soft and flexible. The loss of flexibility results in increased blood pressure, in particular the upper (systolic) pressure. It is considered that if there is a lack of balance in the bioavailability of zinc during childhood and youth this may result in vascular changes as an adult. Documentation shows an inverse association between blood pressure and zinc content in blood serum, which means that a low zinc content seems to be associated with high blood pressure. Low zinc values have been found in active sportsmen. The low level may be explained by high liquid loss due to sweating and/or by a low intake of zinc.

EP 248,810 discloses a seasoning composition containing a salt component and a mineral element/trace element component. The salt component consists of sodium chloride or a mixture of sodium chloride and potassium chloride. The trace elements are selected from zinc, copper, manganese, chromium, selenium or molybdenum and the mineral elements from calcium, phosphorus, magnesium, potassium, sodium, chlorine, fluorine, iodine or iron. The object of the invention is to provide a seasoning composition intended for use in cooking or as a table salt, while being a source of trace element fortification of the daily diet. The preferred object of the invention is to provide a recommended daily intake of two or more trace elements and mineral elements. This seasoning composition can also contain bitterness-reducing agents, especially when potassium chloride is used as salt component, flavouring agent or flavouring enhancer (e.g. monosodium glutamate). The composition can also contain one or more vitamins. It is not mentioned that the choice of salts or amounts is made in order to reduce the effects of sodium, for instance, on the heart and vessels. Nor does the document mention flavour improvement by the choice and the amounts of salts.

One problem of today's commercially available mineral salts, which are intended to reduce the negative effects of sodium and in which part of the salt is replaced by other minerals, is that efforts are only made to reduce the amount of sodium chloride. One difficulty of replacing sodium chloride by, for instance, potassium chloride is that potassium has a much more bitter taste than sodium. Owing to this, most mineral salts are judged to be less pleasant tasting than ordinary salt (NaCl). The choice of NaCl replacement salt has also been directed to taste and not to optimisation of other aspects of the replacement substances. In most cases, these mineral salts still have a NaCl content of about 50%.

Examples of problems relating to salt in cooking are that many minerals easily leach out of food, for instance, when boiled, and that so-called fast food and frozen and fresh ready-to-eat food contain high amounts of sodium chloride, while being poor in other important minerals such as potassium, magnesium and calcium. Cured meats and provisions (charcuterie) and bread are other examples of food containing high amounts of sodium.

Those engaged in hard physical activity or living an active life with a lot of stress may in various ways consume many important minerals or have difficulties in getting enough minerals through the diet. As described above, potassium, magnesium, calcium, folic acid and zinc are essential for a number of vital bodily functions, such as normal muscle function, immune defense, blood pressure and the formation of cells, for example, blood cells and bone forming cells.

### SUMMARY OF THE INVENTION

The above problems are solved by the salt mixture according to the present invention. One object of the present invention is thus to provide a mineral salt mixture in which the amount of harmful sodium chloride is limited and has been replaced by other minerals which are beneficial for the health while keeping their fresh taste of salt.

In a first aspect, the present invention thus relates to a salt mixture with low sodium content for human consumption comprising sodium chloride, potassium chloride, magnesium sulphate, calcium carbonate, folic acid and zinc oxide. In this connection, “low sodium content” means a NaCl content in the salt mixture of less than 40% by weight, preferably less than 35% by weight and most preferably 33% by weight.

The problems are also solved by the present invention in another aspect by a food, a food supplement and a functional food containing the salt mixture described above.

In yet another aspect, the invention relates to use of a salt mixture according to that stated above in food, in industrial or private cooking or as a table salt.

In a final aspect, the present invention relates to use of the salt mixture in industrial or private cooking and as a table salt.

The salt mixture according to the present invention thus has a composition which inhibits the harmful effects of sodium chloride and which can be used as an ordinary flavouring. In normal salt intake (about 11 g/day), the present invention reduces the sodium intake, in a preferred embodiment by 67% compared to the intake of ordinary salt (NaCl). In the present invention, only NaCl replacement substances having documented blood pressure lowering effects are added. The combination of reducing the blood pressure raising sodium content and adding blood pressure lowering minerals and vitamins makes the salt mixture according to the invention double-acting. In addition, the salt mixture according to the invention has a good salt taste without any bitterness, as other mineral salts on the market.

### DETAILED DESCRIPTION OF THE INVENTION

The present invention is a salt mixture with a considerably reduced content of sodium chloride compared to ordinary salt and other mineral salts available on the market. The object of the mineral salt mixture is to reduce the harmful sodium, which is one of the most important causes for high blood pressure, and replace the salt by other minerals having a documented blood pressure lowering effect, while the amounts of the ingredients included in the salt mixture give rise to a fresh salt taste.

The salt mixture according to the invention preferably comprises 30-40% by weight sodium chloride, 49-61% by weight potassium chloride, 9-11% by weight magnesium sulphate, 1.5-2.5% by weight calcium carbonate, 0.0015-0.0025% by weight folic acid and 0.045-0.055% by weight zinc oxide. The salt mixture can also contain iodine in the form of potassium iodide, for example if addition of iodine is compulsory for this type of product.

In a preferred embodiment, the salt mixture comprises 33% by weight sodium chloride, 54.943% by weight potassium chloride, 10% by weight magnesium sulphate, 2% by weight calcium carbonate, 0.002% by weight folic acid, 0.05% by weight zinc oxide and 0.005% by weight potassium iodide.

Flavouring agents can also be added to the salt mixture according to the present invention, such as for instance pepper, onion, garlic, tomato, sweet pepper, basil, parsley, thyme, celery, lime, chili, nettle, rosemary, smoke flavouring, curry, coriander and lemon.

Potassium chloride is used since long as replacement for sodium chloride, and it is an important mineral to help maintain many bodily functions, among other things, the vital sodium/potassium pump in the cells which transports substances in and out of the cells. In the present invention, the potassium chloride content is substantially much higher than in other commercially available mineral salts. Another object of the present invention was not only to reduce the harmful sodium chloride but also to replace it by other substances with documented blood pressure lowering effects. Owing to this, also magnesium, calcium and folic acid have been added. Potassium, calcium and magnesium in combination are important to keep the blood pressure at a healthy level, while folic acid is considered to have a certain blood pressure lowering effect, in particular in women who are sensitive to salt.

Another object of the present invention is to keep the fresh taste of salt, even if the sodium chloride is replaced by potassium chloride and other minerals with a slightly bitter taste.

Yet another object of the present invention is to provide a salt mixture for food from which important minerals such as potassium, magnesium and calcium have leached. Therefore, in a preferred embodiment, the present invention also relates to use of the same in vegetable and animal food intended to be boiled.

Yet another object of the present invention is to provide a salt mixture for food in which folic acid has leached out or been destroyed by heating and/or boiling. Therefore, in a preferred embodiment, the present invention relates to use of the same in vegetable and animal food intended to be boiled or heated in some other way.

Yet another aspect of the present invention is use of a salt mixture according to that stated above in functional food and/or food supplement in order to obtain a salt mixture that meets the daily requirements of a number of important minerals and vitamins, such as potassium, magnesium, calcium, zinc and folic acid for persons in special need thereof, such as persons actively engaged in sports, pregnant women, stressed individuals and other people who for some reason cannot get sufficient amounts of these minerals which are essential for the human body, while reducing the intake of harmful sodium.

In yet another preferred embodiment, the present invention thus comprises a food supplement and a functional food in a preparation selected from the group consisting of capsules, tablets, chewing-gum, powder, beverages, soups and bars and other preparations known by a person skilled in the art. The production thereof is carried by methods and techniques well-known to a person skilled in the art.

By “food supplement” is meant a product which gives the user a supplement (in addition to the dietary content) of one or more nutrients.

By “functional food” is meant food which has been modified to provide specific positive health effects.

In yet another preferred embodiment of the invention, the salt mixture is used in food which is considered to have very high contents of sodium, such as fast food, ready-to-eat food (frozen or fresh), cured meats and provisions and bread.

The following example is only intended to illustrate the beneficial effects of the invention, by using an example of a salt mixture, and is not intended to limit the scope of the present disclosure in any way.

### EXAMPLE

### Comparative Sensory Analysis of Salt Mixtures

To illustrate the good organoleptic properties of the salt mixture according to the present invention, a comparative sensory blind test has been carried out regarding its taste. The test group consisted of eight subjects who blindly tasted two different kinds of salt, a salt mixture according to the invention (Minosel™, bowl 1) and a mineral salt presently available on the market, Seltin® from Cederroth International AB (bowl 2). The criteria tested were the following: which salt tastes best, which salt is most similar to ordinary table salt, i.e. sodium chloride, which salt has the most bitter aftertaste and which salt looks to taste best.

### Material

TABLE 1
Ingredients Minosel ™ per 100 g.

| Ingredient | Amount | |
|---|---|---|
| Potassium chloride | 54.943 | g |
| Sodium chloride | 33 | g |
| Magnesium sulphate | 10 | g |
| Calcium carbonate | 2 | g |
| Potassium iodide | 0.005 | g |
| Folic acid | 0.002 | g |
| Zinc oxide | 0.05 | g |

TABLE 2
Ingredients Seltin ® per 100 g.

| Ingredient | Amount |
|---|---|
| Potassium chloride | 40 g |
| Sodium chloride | 50 g |
| Magnesium sulphate | 9.995 g |
| A iodine salt | 0.005 g |

Results from a Comparative Sensory Analysis of Salt Mixtures

The results are shown below in tables.

Question 1 Which salt tastes best?

| | Number of | |
|---|---|---|
| | answers | Percentage |
| Bowl 1 | 5 | 63% |
| Bowl 2 | 2 | 25% |
| No reply | 1 | 13% |

Question 2 Which salt tastes most like ordinary household salt?

| | Number of | |
|---|---|---|
| | answers | Percentage |
| Bowl 1 | 5 | 63% |
| Bowl 2 | 1 | 13% |
| No reply | 2 | 25% |

Question 3 Which salt has the most bitter aftertaste?

| | Number of | |
|---|---|---|
| | answers | Percentage |
| Bowl 1 | 2 | 25% |
| Bowl 2 | 5 | 63% |
| No reply | 1 | 13% |

Question 4 Which salt looks to have the best taste?

| | Number of | |
|---|---|---|
| | answers | Percentage |
| Bowl 1 | 2 | 25% |
| Bowl 2 | 5 | 63% |
| No reply | 0 | 0% |

### CONCLUSION

The sensory analysis clearly shows that the salt mixture in bowl 1, i.e. a salt mixture according to the invention, tastes better than Seltin®, reminds more of “ordinary” salt than Seltin® and has a less bitter aftertaste. On the hand, Seltin® apparently looks to have a better taste than Minosel™, the salt mixture according to the invention.

1. A salt mixture with low sodium content for human consumption, comprising 30-40% by weight sodium chloride, 49-61% by weight potassium chloride, 9-11% by weight magnesium sulphate, 1.5-2.5% by weight calcium carbonate, 0.001-0.0025% by weight folic acid and 0.045-0.055% by weight zinc oxide.

2. A salt mixture as claimed in claim 1, further comprising potassium iodide.

3. A salt mixture as claimed in claim 2, comprising 33% by weight sodium chloride, 54.943% by weight potassium chloride, 10% by weight magnesium sulphate, 2% by weight calcium carbonate, 0.002% by weight folic acid, 0.05% by weight zinc oxide and 0.005% by weight potassium iodide.

4. A salt mixture as claimed in claim 1, further comprising at least one flavouring additive.

5. A salt mixture as claimed in claim 4, wherein said at least one flavouring additive is selected from the group consisting of pepper, onion, garlic, tomato, sweet pepper, basil, parsley, thyme, celery, lime, chili, nettle, rosemary, smoke flavouring, curry, coriander and lemon.

6. A salt mixture as claimed in claim 1, comprising <40% by weight NaCl.

7. A food comprising the salt mixture as claimed in claim 1.

8. A food supplement comprising the salt mixture as claimed in claim 1.

9. A functional food comprising the salt mixture as claimed in claim 1.

10. A food supplement as claimed in claim 8, in a preparation selected from the group consisting of capsules, tablets, chewing-gum, powder, beverages, soups and bars.

11. A method of preparing food with the salt mixture as claimed in claim 1 comprising including said salt mixture in said food.

12. The method of claim 11, wherein the food is selected from the group consisting of fast food, ready-to-eat food, cured meats and provisions, bread and food intended to be boiled.

13. A method of industrial or private cooking comprising adding the salt mixture as claimed in claim 1 to a food being cooked.

14. A table salt comprising the salt mixture as claimed in claim 1.

15. The salt mixture of claim 6, comprising <35% by weight NaCl.

16. The salt mixture of claim 6, comprising 33% by weight NaCl.

17. A functional food as claimed in claim 9, in a preparation selected from the group consisting of capsules, tablets, chewing-gum, powder, beverages, soups and bars
